(19) United States
(12) Patent Application Publication
(10) Pub. No.: US 2025/0256739 A1
(43) Pub. Date: Aug. 14, 2025

(54) SIGNAL PROCESSING DEVICE

(71) Applicant: Hitachi Astemo, Ltd., Hitachinaka-shi, Ibaraki (JP)

(72) Inventor: Ryota MITA, Hitachinaka-shi, Ibaraki (JP)

(73) Assignee: Hitachi Astemo, Ltd., Hitachinaka-shi, Ibaraki (JP)

(21) Appl. No.: 18/702,398

(22) PCT Filed: Aug. 24, 2022
(86) PCT No.: PCT/JP2022/031910

§ 371 Date: Apr. 18, 2024

(30) Foreign Application Priority Data
Oct. 22, 2021 (JP) 2021-173398

(51) Int. Cl. B60W 60/00; B60W 30/16; B60W 40/076

(52) U.S. Cl. CPC B60W 60/0027; B60W 30/16; B60W 40/076

(57) ABSTRACT

Provided is a signal processing device capable of more surely keeping a vehicle-to-vehicle distance between a leading vehicle and a host vehicle in traveling by following, by more accurately determining a cause for losing track of the leading vehicle by an external environment sensor as compared to conventional signal processing devices. The integration unit 12 performs integration processing of the external environment information acquired by the external environment sensor 1 mounted on the host vehicle V and the host vehicle travel information acquired by the vehicle sensor 6. The behavior prediction unit 9 predicts the behavior at a future time of the host vehicle V and another vehicle detected by the external environment sensor 1, based on the integration result from the integration unit 12. The road shape acquisition unit 10 obtains the road shape information (gradient information) on the traveling road surface of the host vehicle V and the other vehicle at the future time. The departure determination unit 11 determines whether the other vehicle departs from the detection range of the external environment sensor 1 at the future time, based on the behavior prediction result of the host vehicle V and the other vehicle and the road shape information (gradient information). The integration unit 12 uses the behavior prediction result for the integration processing in accordance with the determination result from the departure determination unit 11.

### TECHNICAL FIELD

The present invention relates to a signal processing device for a vehicle.

### BACKGROUND ART

Recently, autonomous driving of a vehicle (also referred to as an autonomous driving vehicle) with a vehicle control device for autonomous driving mounted thereon has been in practical use. In relation to this, vehicle control has been known in which for example, an autonomous driving vehicle travels by following another vehicle (hereinafter, also referred to as a leading vehicle) driving ahead while acquiring information on the leading vehicle from an external environment sensor so as to keep the vehicle-to-vehicle distance from the leading vehicle.

Further, Patent Literature 1 discloses an autonomous driving control device in which when the external environment sensor of the host vehicle has lost track of the leading vehicle, it is determined whether the leading vehicle is present on a route of the host vehicle based on route candidates of the leading vehicle obtained from map information, and when it is determined that the leading vehicle is present on the route of the host vehicle, the acceleration of the host vehicle is controlled to be limited.

### CITATION LIST

### Patent Literature

Patent Literature 1: JP 2016-103131 A

### SUMMARY OF INVENTION

### Technical Problem

In traveling of an autonomous driving vehicle (hereinafter, also referred to as a host vehicle), traveling an overpass or a sag with continuous ascending and descending gradients is also presumed.

For example, when the host vehicle travels an overpass by following a leading vehicle so as to keep the vehicle-to-vehicle distance therebetween, in a scene where the leading vehicle is positioned outside a detection range of an external environment sensor of the host vehicle due to a large difference in gradient of the road surface where the host vehicle and the leading vehicle are traveling, a phenomenon occurs in which leading vehicle information from the eternal environment sensor is temporarily lost (hereinafter, also referred to as a temporary loss).

As described above, when the host vehicle accelerates or the leading vehicle decelerates due to the temporary loss of the leading vehicle information from the external environment sensor despite the presence of the leading vehicle ahead of the host vehicle on a travel route, the vehicle-to-vehicle distance having been kept so far is reduced. Further, immediately afterwards, when the leading vehicle information from the external environment sensor is recovered, the host vehicle recognizes as if the leading vehicle suddenly appears, which could pose a danger of the host vehicle and the leading vehicle rapidly approaching or colliding against each other.

Prior art of Patent Literature 1 first calculates, from the external environment sensor and map information, the route where the host vehicle travels and candidates for a route where the leading vehicle is traveling from now. Next, based on the relation among the route of the host vehicle, the candidates for the route of the leading vehicle, and the detection range of the external environment sensor, the timing when the leading vehicle is lost is computed for each candidate for the route of the leading vehicle. Then, the timing at which the leading vehicle is lost in the calculated route candidate and the timing at which the leading vehicle has been actually lost by the external environment sensor are compared for consistency to determine which route the leading vehicle has actually selected, so that a cause for the temporary loss of the leading vehicle can be accurately identified.

Herein, traveling an overpass in Patent Literature 1 will be studied. First, a general overpass has only one straight route as a route. Further, on the overpass, there are few occasions in which a vehicle decelerates to safely make a turn, for example, as in a route with left and right turns at an intersection, and the vehicle speed is likely to be relatively increased. Thus, on the overpass, particularly, the host vehicle and the leading vehicle are more likely to rapidly become closer to each other. However, Patent Literature 1 does not address traveling a single straight route, and lacks consideration for gradients, despite the fact that the gradients on the traveling road surface cause the temporary loss of the leading vehicle on the overpass.

The method for determining the cause for the temporary loss from the route candidates for the leading vehicle, as in Patent Literature 1, has a problem in that the temporary loss in traveling an overpass or a sag cannot be accurately determined.

The present invention has been made in view of the aforementioned problem, and provides a signal processing device capable of more surely keeping a vehicle-to-vehicle distance between a leading vehicle and a host vehicle in traveling by following, by more accurately determining a cause for losing track of the leading vehicle by an external environment sensor as compared to conventional signal processing devices.

### Solution to Problem

To achieve the aforementioned object, the present invention is a signal processing device including: an integration unit that performs integration processing of external environment information acquired by an external environment sensor mounted on a host vehicle and host vehicle travel information acquired by a vehicle sensor; and a behavior prediction unit that predicts behavior at a future time of the host vehicle and another vehicle detected by the external environment sensor, based on an integration result from the integration unit, in which the behavior prediction unit includes: a road shape acquisition unit that obtains road shape information on a traveling road surface of the host vehicle and the other vehicle at the future time; and a departure determination unit that determines whether the other vehicle departs from a detection range of the external environment sensor at the future time, based on a behavior prediction result of the host vehicle and the other vehicle and the road shape information, and the integration unit uses the behavior prediction result for the integration processing in accordance with a determination result from the departure determination unit.

### Advantageous Effects of Invention

According to the present invention, it is possible to provide a signal processing device capable of more surely keeping a vehicle-to-vehicle distance between a leading vehicle and a host vehicle in traveling by following, by more accurately determining a cause for losing track of the leading vehicle by an external environment sensor as compared to conventional signal processing devices.

Problems, configurations, and advantageous effects other than those described above will be clarified by the description of the following embodiments.

### BRIEF DESCRIPTION OF DRAWINGS

FIG. 1 is a configurational diagram showing a vehicle control device AD1 of an autonomous driving vehicle according to the present invention.

FIG. 2 is a configurational view showing an example of an external environment sensor 1 of FIG. 1.

FIG. 3 is a flowchart of processing performed by a behavior prediction unit 9 of FIG. 1.

FIG. 4 shows a scene at a current time t1, and explanatory views of an integration result FU1 and a behavior prediction result CA1 in an embodiment 1.

FIG. 5 is a flowchart of processing performed by an integration unit 12 of FIG. 1.

FIG. 6 shows a scene at a current time t2, and explanatory views of an integration result FU2 and an integration result FU3 in the embodiment 1.

FIG. 7 shows a scene at a current time t101, and explanatory views of an integration result FU101 and an integration result FU102 in an embodiment 2.

### DESCRIPTION OF EMBODIMENTS

Hereinafter, a signal processing device according to some embodiments will be described in detail with reference to the drawings. It should be noted that the present embodiments are mere examples for embodying the present invention and do not limit the technical scope of the present invention. Common components in the drawings are assigned the same reference signs.

### Embodiment 1

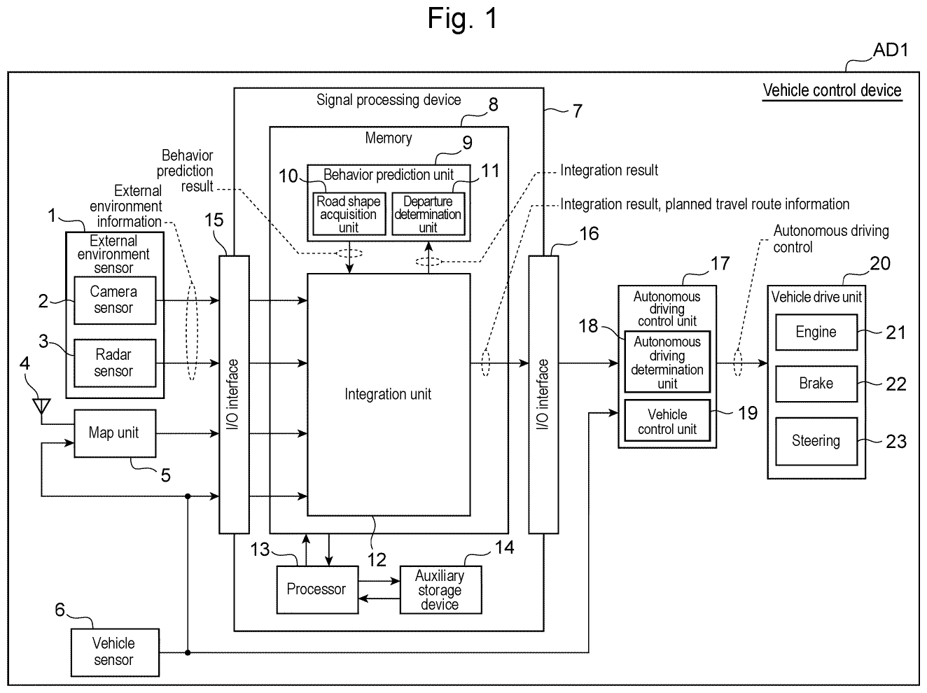

FIG. 1 is a configurational diagram of the vehicle control device AD1 mounted on an autonomous driving vehicle (host vehicle V). The vehicle control device AD1 includes a signal processing device 7, an autonomous driving control unit 17, an external environment sensor 1, a map unit 5, a vehicle sensor 6, and a vehicle drive unit 20.

The signal processing device 7, the autonomous driving control unit 17, and the map unit 5 acquire, from the vehicle sensor 6, operation amounts of an engine 21, a brake 22, and steering 23 that are controlled by the vehicle drive unit 20.

The external environment sensor 1 includes a camera sensor 2 and a radar sensor 3. The camera sensor 2 acquires object information (external environment information) detected from an image of the surrounding of the host vehicle V and outputs the acquired object information to the signal processing device 7. The radar sensor 3 acquires object information (external environment information) detected from a distance to a predetermined location in the surrounding of the host vehicle V and outputs the acquired object information to the signal processing device 7. Note that the object information includes the size, position, speed, acceleration, orientation, type, detected state, and the like of the detected object.

The map unit 5 includes an antenna 4. The antenna 4 receives a satellite reception signal (hereinafter, a GNSS signal) in a Global Navigation Satellite System (hereinafter, a GNSS). The map unit 5 includes a map database and a locator. The map unit 5 computes host vehicle positional information by means of the locator based on the received GNSS signal, selects the surrounding map information from the map database, and outputs the host vehicle positional information and the surrounding map information to the signal processing device 7. Note that the map information includes detailed information necessary for autonomous driving, such as roads, signs, and terrestrial objects.

The vehicle sensor 6 acquires host vehicle travel information, such as operating information on the engine 21, operating information on the brake 22, and operating information on the steering 23, and outputs the acquired host vehicle travel information to the signal processing device 7, the autonomous driving control unit 17, and the map unit 5.

Herein, the signal processing device 7 includes a processor 13, a memory 8, an I/O interface 15, an I/O interface 16, and an auxiliary storage device 14. The I/O interface 15 is connected to the external environment sensor 1, the map unit 5, and the vehicle sensor 6, and the I/O interface 16 is connected to the autonomous driving control unit 17. The I/O interface 15 and the I/O interface 16 are connected to the external environment sensor 1, the map unit 5, the vehicle sensor 6, and the autonomous driving control unit 17 via a LAN (Local Area Network) or a CAN (Controller Area Network).

The auxiliary storage device 14 is configured with a nonvolatile storage medium and retains programs, tables, and the like.

The integration unit 12 and the behavior prediction unit 9 are loaded as programs on the memory 8 and are executed by the processor 13. Note that the behavior prediction unit 9 includes a road shape acquisition unit 10 and a departure determination unit 11.

The integration unit 12 receives external environment information from the external environment sensor 1, receives host vehicle positional information, surrounding map information, and preset planned travel route information from the map unit 5, and receives host vehicle travel information from the vehicle sensor 6. The integration unit 12 merges the host vehicle travel information into the surrounding map information based on the host vehicle positional information. The integration unit 12 closely examines the external environment information and removes inaccurate information such as a detection error made by the sensor, and then, generates accurate object information to merge the object information into the surrounding map information. The integration unit 12 generates an integration result in which the host vehicle travel information and the object information are merged (integrated) into the surrounding map information (also referred to as integration processing). The integration unit 12 outputs the integration result to the behavior prediction unit 9, and the integration result and the planned travel route information to the autonomous driving control unit 17.

The behavior prediction unit 9 receives the integration result from the integration unit 12 and calculates the positional relation between the host vehicle V and the surrounding object at a future time or the like, and generates a behavior prediction result in which the host vehicle travel information and the object information at the future time that are obtained by the calculation are merged into the surrounding map information. The behavior prediction unit 9 stores and reads the generated behavior prediction result and outputs the behavior prediction result to the integration unit 12, as necessary.

The road shape acquisition unit 10 extracts a leading vehicle LV from the behavior prediction result and acquires gradient information on a traveling road surface of the leading vehicle LV at the future time. Further, the road shape acquisition unit 10 acquires gradient information on a traveling road surface of the host vehicle V at the future time from the behavior prediction result. Note that the gradient information on the traveling road surface is a gradient value acquired from the surrounding map information based on the positional information on the host vehicle V and the leading vehicle LV in the behavior prediction result.

Note that the gradient information on the traveling road surface may be directly acquired from the surrounding map information when the gradient value is included in the surrounding map information or the gradient value may be calculated from information on road coordinate points (latitude, longitude, altitude) that define the road shape included in the surrounding map information to be acquired.

The departure determination unit 11 acquires the gradient information on the traveling road surface of each of the host vehicle V and the leading vehicle LV at the future time from the road shape acquisition unit 10 and determines whether the leading vehicle LV departs from a detection range of the external environment sensor 1 at the future time.

An autonomous driving determination unit 18 of the autonomous driving control unit 17 receives the integration result and the planned travel route information from the integration unit 12 and the host vehicle travel information from the vehicle sensor 6, and calculates the behavior, route, speed, or the like necessary for autonomous driving. The vehicle control unit 19 of the autonomous driving control unit 17 receives the calculation result from the autonomous driving determination unit 18 and controls (autonomous driving control) the vehicle drive unit 20 (engine 21, brake 22, steering 23).

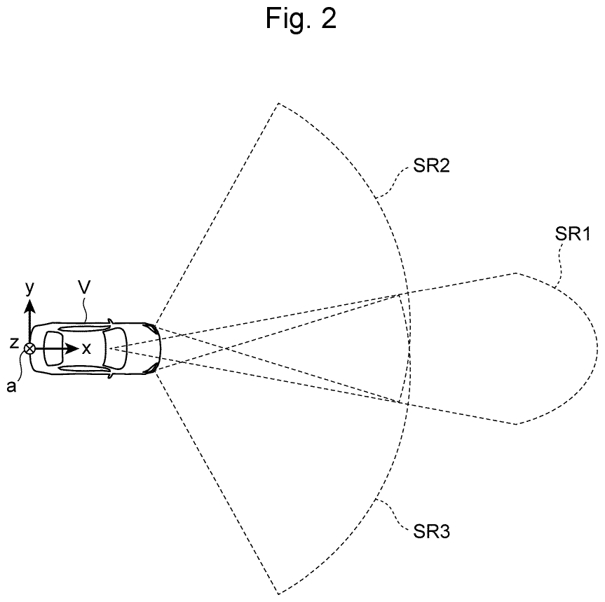

Next, FIG. 2 is a view showing the configuration of the external environment sensor 1 in the autonomous driving vehicle (host vehicle V). One camera sensor 2 and two radar sensors 3 are provided on the front side of the host vehicle V. A detection range SR1 of the camera sensor 2 is set facing the front, a detection range SR2 of the radar sensor 3 on the front-left side is set slightly facing the left, and a detection range SR3 of the radar sensor 3 on the front-right side is set slightly facing the right, and with the detection ranges overlapping with each other, the external environment sensor 1 obtains a wide detection range. An origin a of coordinates of the host vehicle V is defined at the rear end at the center of the vehicle, and an advancing direction is represented by an x-direction, a lateral direction by a y-direction, and a height direction by a z-direction.

Hereinafter, description will be made using an example of traveling a road (overpass) ascending and continuously descending.

Upon executing the autonomous driving by the vehicle control device AD1, the integration unit 12, the behavior prediction unit 9, the road shape acquisition unit 10, and the departure determination unit 11 start processing.

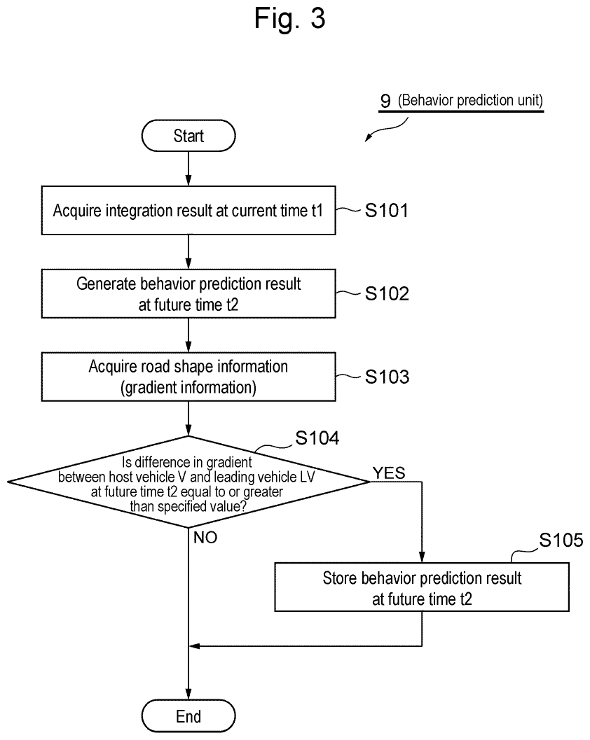

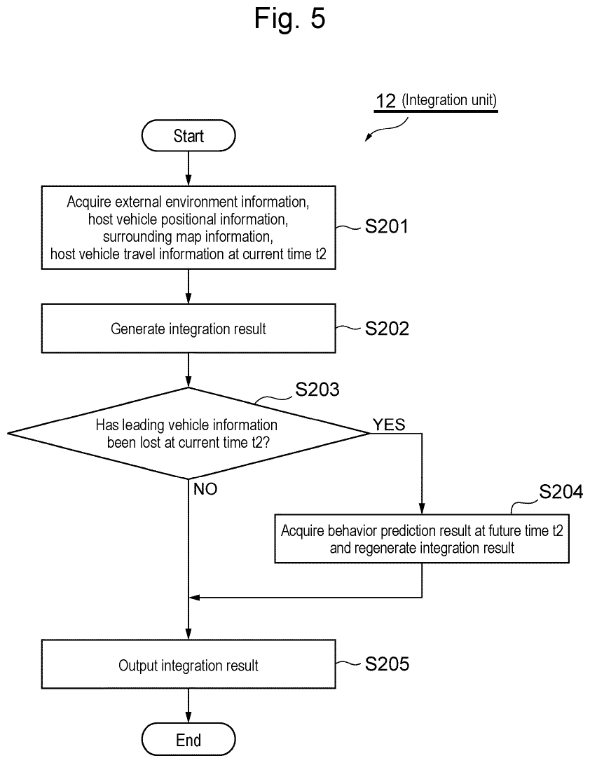

FIG. 3 is a flowchart of processing performed by the behavior prediction unit 9, and FIG. 5 is a flowchart of processing performed by the integration unit 12. Hereinafter, the flowchart of processing performed by the behavior prediction unit 9 will be described.

First, in step S101, the behavior prediction unit 9 acquires the integration result FU1 at the current time t1 from the integration unit 12.

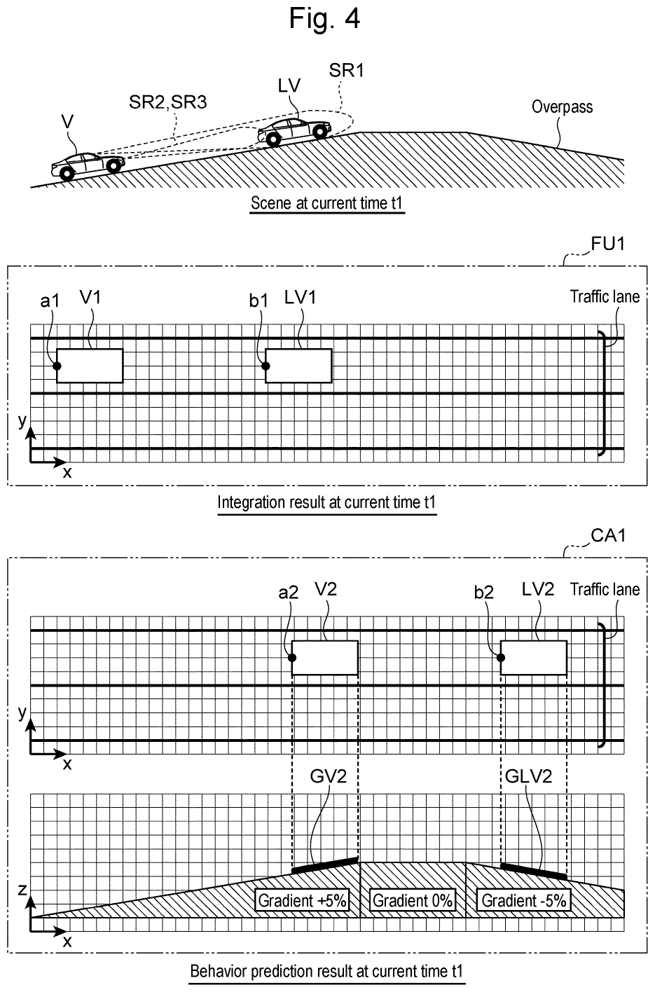

Herein, FIG. 4 shows a scene at the current time t1, and views of the integration result FU1 and the behavior prediction result CA1.

The scene at the current time t1 of FIG. 4 is a scene in which the host vehicle V is traveling an overpass by following the leading vehicle LV. The host vehicle V is traveling at a speed decelerated from a predetermined speed set by the host vehicle V, in order to keep a vehicle-to-vehicle distance from the leading vehicle LV. It is perceived from the scene that the host vehicle V and the leading vehicle LV are traveling an ascending gradient on the overpass, and the external environment sensor 1 is detecting the leading vehicle LV, which is positioned within the detection ranges SR1, SR2, SR3 of the external environment sensor 1 of the host vehicle V.

The integration result FU1 of FIG. 4 is the integration result generated by the integration unit 12 by merging the host vehicle travel information and the object information at the current time t1 into the surrounding map information. For the description, FIG. 4 shows a traffic lane of the road, host vehicle information V1 indicating the position and the size of the host vehicle V, and leading vehicle information LV1 indicating the position and the size of the leading vehicle LV, in a grid in the x-y directions. Regarding the positions of the host vehicle information V1 and the leading vehicle information LV1, the positions of an origin a1 of coordinates of the host vehicle V and an origin b1 of coordinates of the leading vehicle LV are computed from the host vehicle travel information and the object information in the integration result, and the sizes of the vehicles are defined in the surrounding map information on the basis of these origins.

The description of the steps of FIG. 3 will be resumed.

In step S102, the behavior prediction unit 9 generates the behavior prediction result CA1 at a future time t2. The future time t2 may be a time preset relative to the current time t1 or may be a time set in accordance with the information on the host vehicle V and the leading vehicle LV, such as the speed, acceleration, advancing direction, traveling traffic lane, and surrounding traffic environment.

The behavior prediction result CA1 of FIG. 4 shows the behavior prediction result generated such that the behavior prediction unit 9 computes positions of an origin a2 of coordinates of the host vehicle V and an origin b2 of coordinates of the leading vehicle LV at the future time t2, and the sizes of the vehicles are defined in the surrounding map information on the basis of these origins.

The origin a2 of coordinates and the origin b2 of coordinates are calculated using the information on the host vehicle V and the leading vehicle LV, such as the speed, acceleration, advancing direction, and traveling traffic lane, from the host vehicle travel information, the object information, and the surrounding map information in the integration result FU1.

In the behavior prediction result CA1, host vehicle information V2 and leading vehicle information LV2 indicate a vehicle-to-vehicle relation in the coordinate system with x-y directions and host vehicle information GV2 and leading vehicle information GLV2 indicate a gradient relation in the coordinate system with x-y directions.

In step S103, the road shape acquisition unit 10 of the behavior prediction unit 9 acquires, from the surrounding map information, the gradient values as road shape information (gradient information) on the traveling road surface of the host vehicle V and the leading vehicle LV at the future time t2, based on the positions of the host vehicle information GV2 and the leading vehicle information GLV2. The actual gradient of the overpass differs depending on the roads, but as an example here, the gradient value in the host vehicle information GV2 is assumed to be +5% and the gradient value in the leading vehicle information GLV2 is assumed to be −5%.

In step S104, the departure determination unit 11 of the behavior prediction unit 9 determines whether the leading vehicle LV departs from the detection range of the external environment sensor 1 at the future time t2. The departure determination unit 11 compares the gradient value of the host vehicle V and the gradient value of the leading vehicle LV that are acquired in step S103 to compute the difference (difference in gradient) therebetween, and proceeds to step S105 when the difference is equal to or greater than a specified value (step S104: YES), and ends the flow when the difference is less than the specified value (step S104: NO).

In the following example, since the difference in gradient between the host vehicle V and the leading vehicle LV is greater than the specified value, the determination in step S104 is YES (departure is determined).

Gradient value of host vehicle V: +5% (a)

Gradient value of leading vehicle LV: −5% (b)

Difference in gradient (a−b): 10% (c)

Specified value: 7% (d)
Determination in S104 (c≥d?): YES (departure is determined)

In traveling the overpass, as the difference in gradient between the host vehicle V and the leading vehicle LV increases, the external environment sensor 1 is more likely to fail to detect the leading vehicle LV because the leading vehicle LV is positioned outside the detection range of the external environment sensor 1 or enters a dead angle of an ascending gradient. The departure determination unit 11 utilizes such a phenomenon. That is, the difference in gradient with which the external environment sensor 1 cannot perform the detection is set in advance as the specified value, and when the difference in gradient of the traveling road surface between the host vehicle V and the leading vehicle LV is significant to be equal to or greater than the specified value, the departure determination unit 11 acknowledges that the leading vehicle LV is positioned outside the detection ranges SR1, SR2, SR3 of the external environment sensor 1 and determines the departure. Note that in the present example, for the description, the specified value of the gradient is set at 7%, but may be set at the optimum value considering the actual vehicle shape, the attachment position of the external environment sensor, and the like.

In step S105, the behavior prediction unit 9 stores the behavior prediction result CA1 at the future time t2 in the memory 8 and ends the flow.

Next, the flowchart of the processing performed by the integration unit 12 will be described.

In step S201, the integration unit 12 acquires the external environment information from the external environment sensor 1, the host vehicle positional information and the surrounding map information from the map unit 5, and the host vehicle travel information from the vehicle sensor 6 at the current time t2 (corresponding to the future time t2 in steps S102, S103, S104, S105 of the behavior prediction unit 9).

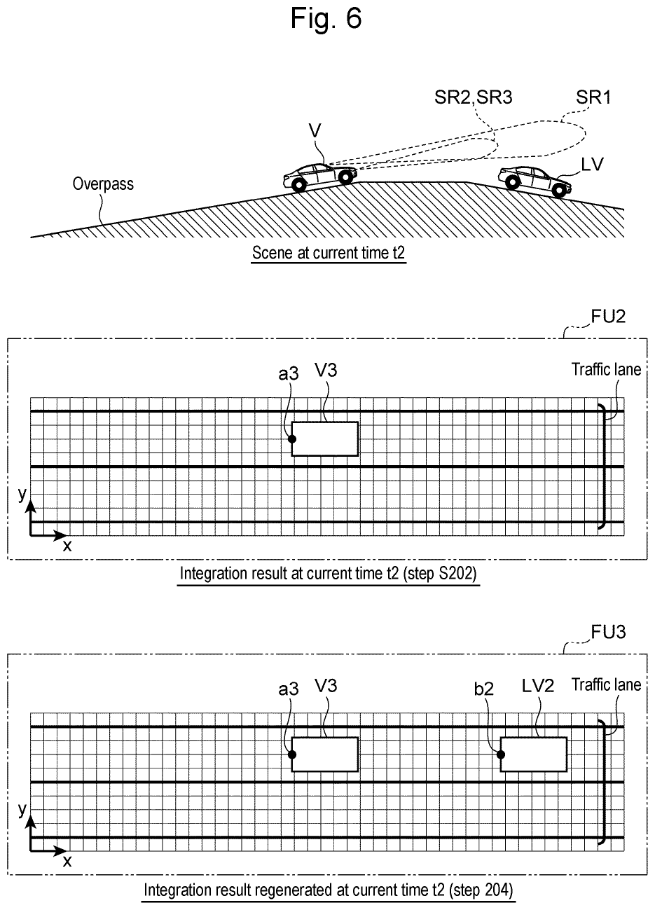

Herein, FIG. 6 shows a scene at the current time t2, and views of the integration result FU2 and the regenerated integration result FU3.

In FIG. 6, the scene at the current time t2 illustrates the host vehicle V traveling the overpass by following the leading vehicle LV, and the time proceeds from the current time t1 described in FIG. 4. The host vehicle V is traveling an ascending gradient of the overpass, while the leading vehicle LV is traveling a descending gradient of the overpass. It is perceived from the scene that at the current time t2, the leading vehicle LV departs from the detection ranges SR1, SR2, SR3 of the external environment sensor 1 of the host vehicle V, and the external environment sensor 1 has lost track of the leading vehicle LV.

In step S202, the integration unit 12 generates the integration result FU2 at the current time t2 based on the information acquired in step S201. Since the external environment sensor 1 has lost track of the leading vehicle LV, the integration result FU2 has host vehicle information V3, but no leading vehicle information.

As described above, despite the presence of the leading vehicle LV ahead of the host vehicle V, if the integration result FU2 without the leading vehicle information is output to the autonomous driving control unit 17 in the subsequent step, the vehicle-to-vehicle distance between the host vehicle V and the leading vehicle LV is reduced, which could put them in danger. That is, if the autonomous driving determination unit 18 determines from the integration result FU2 that the leading vehicle LV as a target vehicle to be followed has disappeared and the vehicle control unit 19 performs acceleration control of the host vehicle V so as to return the speed to a predetermined speed, the vehicle-to-vehicle distance between the host vehicle V and the leading vehicle LV, which has been kept so far, is reduced.

In step S203, the integration unit 12 determines whether the leading vehicle information is lost at the current time t2. The integration unit 12 monitors how the state detected by the external environment sensor 1 has changed between the current time t2 and the time before the current time t2, and proceeds to step S204 when a detected state has changed to an undetected state and the leading vehicle information is lost (step S203: YES), and proceeds to step S205 in other cases (step S203: NO).

In step S204, the integration unit 12 acquires, from the behavior prediction unit 9, the stored behavior prediction result CA1 at the future time t2 (corresponding to the current time t2). The integration unit 12 compares the integration result FU2 and the behavior prediction result CA1, and makes an origin a3 of coordinates of the host vehicle information V3 and the origin a2 of coordinates of the host vehicle information V2 consistent with each other. The integration unit 12 calculates the positional relation between the origin a3 of coordinates of the host vehicle information V3 and the origin b2 of coordinates of the leading vehicle information LV2 and computes the position of the origin b2 of coordinates of the leading vehicle information LV2 in the integration result FU2. The integration unit 12 defines the origin b2 of coordinates in the integration result FU2 and defines the size of the leading vehicle LV based on the origin b2 of coordinates to regenerate the integration result FU2 as the integration result FU3.

That is, even if the external environment sensor 1 actually loses track of the leading vehicle LV at the current time t2, the integration unit 12 uses the behavior prediction result CA1 computed and stored in advance in the behavior prediction unit 9 to merge the leading vehicle information LV2 into the integration result FU2, so that the integration result FU2 can be regenerated (integration processing) as the integration result FU3 matching the actual situation.

In step S205, the integration unit 12 outputs, to the autonomous driving control unit 17, the planned travel route information and the integration result generated in step S202 or the integration result regenerated in step S204.

With the aforementioned processing, in the signal processing device 7 of the vehicle control device AD1, the behavior prediction unit 9 generates and stores the behavior prediction result CA1 at the future time t2 of the host vehicle V and the leading vehicle LV and the road shape acquisition unit 10 acquires the road shape information (gradient information) on the traveling road surface of the host vehicle V and the leading vehicle LV at the future time t2, so that the departure determination unit 11 can determine whether the leading vehicle LV departs from the detection ranges SR1, SR2, SR3 of the external environment sensor 1 at the future time t2.

Further, in the signal processing device 7 of the vehicle control device AD1, when the leading vehicle LV actually departs from the detection ranges SR1, SR2, SR3 of the external environment sensor 1 at the current time t2 (corresponding to the future time t2), the integration unit 12 acquires the behavior prediction result CA1 corresponding to the current time t2 (instead of the external environment information acquired by the external environment sensor 1), and can regenerate the integration result FU3 in which the leading vehicle information LV2 is merged into the integration result FU2 (in other words, the integration result FU2 interpolated with the leading vehicle information LV2).

Further, in the signal processing device 7 of the vehicle control device AD1, when the leading vehicle information acquired by the external environment sensor 1 is temporarily lost at the current time t2, the integration unit 12 outputs the planned travel route information and the integration result FU3 to the autonomous driving control unit 17, so that the autonomous driving control unit 17 performs vehicle control using the leading vehicle information LV2 in the integration result FU3, thus suppressing a phenomenon in which the host vehicle V accelerates due to losing track of the leading vehicle LV as a target to be followed. As a result, the host vehicle V and the leading vehicle LV can safely travel keeping an adequate vehicle-to-vehicle distance therebetween.

That is, the signal processing device 7 includes the integration unit 12 and the behavior prediction unit 9, and the behavior prediction unit 9 includes the road shape acquisition unit 10 and the departure determination unit 11. The integration unit 12 performs integration processing of the external environment information acquired by the external environment sensor 1 mounted on the host vehicle V and the host vehicle travel information acquired by the vehicle sensor 6. The behavior prediction unit 9 predicts the behavior at a future time of the host vehicle V and another vehicle detected by the external environment sensor 1, based on the integration result from the integration unit 12. The road shape acquisition unit 10 obtains the road shape information (gradient information) on the traveling road surface of the host vehicle V and the other vehicle at the future time. The departure determination unit 11 determines whether the other vehicle departs from the detection range of the external environment sensor 1 at the future time, based on the behavior prediction result of the host vehicle V and the other vehicle and the road shape information (gradient information). The integration unit 12 uses the behavior prediction result for the integration processing in accordance with the determination result from the departure determination unit 11.

According to the present embodiment, a cause for losing track of the leading vehicle LV by the external environment sensor 1 can be more accurately determined as compared to the conventional signal processing devices, so that it is possible to provide the signal processing device 7 capable of more surely keeping a vehicle-to-vehicle distance between the leading vehicle LV and the host vehicle V in traveling by following.

### Embodiment 2

Next, an example of traveling a road (sag) descending and continuously ascending will be described in an embodiment 2.

Note that the embodiment 2 is an example of traveling a sag in place of the travel road of the embodiment 1, and the configurations of the vehicle control device AD1 (including the signal processing device 7) described in FIG. 1 and the external environment sensor 1 described in FIG. 2, and the flowcharts of the processing performed by the behavior prediction unit 9 and the integration unit 12 described in FIG. 3 and FIG. 5, respectively, are the same as those of the embodiment 1 and thus, the description will be omitted.

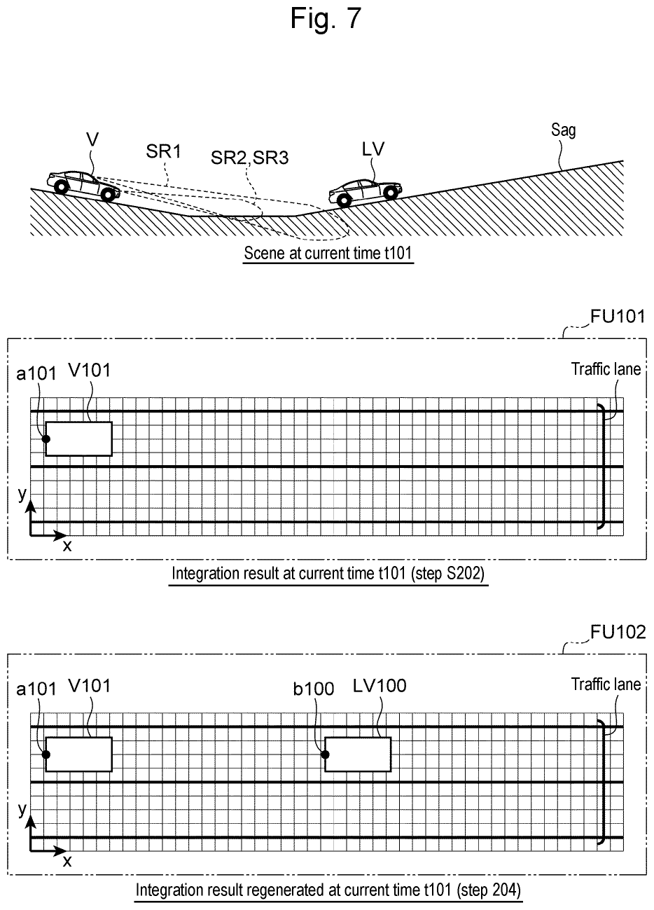

FIG. 7 shows a scene at the current time t101, and views of the integration result FU101 and the regenerated integration result FU102.

In FIG. 7, the scene at the current time t101 is a scene in which the host vehicle V is traveling a sag by following the leading vehicle LV. The host vehicle V is traveling at a speed decelerated from a predetermined speed set by the host vehicle V, in order to keep a vehicle-to-vehicle distance from the leading vehicle LV. The host vehicle V is traveling a descending gradient of the sag, while the leading vehicle LV is traveling an ascending gradient of the sag. It is perceived from the scene that at the current time t101, the leading vehicle LV departs from the detection ranges SR1, SR2, SR3 of the external environment sensor 1 of the host vehicle V and the external environment sensor 1 has lost track of the leading vehicle LV.

Hereinafter, the processing performed by the integration unit 12 will be described using the flowchart.

In step S202, the integration unit 12 generates the integration result FU101 at the current time t101 based on the information acquired in step S201. Since the external environment sensor 1 has lost track of the leading vehicle LV, the integration result FU101 has host vehicle information V101, but no leading vehicle information.

As described above, despite the presence of the leading vehicle LV ahead of the host vehicle V, if the integration result FU101 without the leading vehicle information is output to the autonomous driving control unit 17 in the subsequent step, the vehicle-to-vehicle distance between the host vehicle V and the leading vehicle LV is reduced, which could put them in danger. That is, if the autonomous driving determination unit 18 determines from the integration result FU101 that the leading vehicle LV as a target vehicle to be followed has disappeared and the vehicle control unit 19 performs acceleration control of the host vehicle V so as to return the speed to a predetermined speed, the vehicle-to-vehicle distance between the host vehicle V and the leading vehicle LV, which has been kept so far, is reduced.

In step S203, the integration unit 12 determines whether the leading vehicle information is lost at the current time t101. The integration unit 12 monitors how the state detected by the external environment sensor 1 has changed between the current time t101 and the time before the current time t101, and proceeds to step S204 when a detected state has changed to an undetected state and the leading vehicle information is lost (step S203: YES), and proceeds to step S205 in other cases (step S203: NO).

In step S204, the integration unit 12 acquires, from the behavior prediction unit 9, the stored behavior prediction result (not shown) at the future time t101 (corresponding to the current time t101). The integration unit 12 compares the integration result FU101 and the behavior prediction result, and makes an origin a101 of coordinates of the host vehicle information V101 and an origin (not shown) of coordinates of the host vehicle information in the behavior prediction result consistent with each other. The integration unit 12 calculates the positional relation between the origin a101 of coordinates of the host vehicle information V101 and an origin b100 of coordinates of the leading vehicle information LV100 in the behavior prediction result and computes the position of the origin b100 of coordinates of the leading vehicle information LV100 in the integration result FU101. The integration unit 12 defines the origin b100 of coordinates in the integration result FU101 and defines the size of the leading vehicle LV based on the origin b100 of coordinates to regenerate the integration result FU101 as the integration result FU102.

That is, even if the external environment sensor 1 actually loses track of the leading vehicle LV at the current time t101, the integration unit 12 uses the behavior prediction result computed and stored in advance in the behavior prediction unit 9 to merge the leading vehicle information LV100 into the integration result FU101, so that the integration result FU101 can be regenerated (integration processing) as the integration result FU102 matching the actual situation.

In step S205, the integration unit 12 outputs, to the autonomous driving control unit 17, the planned travel route information and the integration result generated in step S202 or the integration result regenerated in step S204.

With the aforementioned processing, in the signal processing device 7 of the vehicle control device AD1, the behavior prediction unit 9 generates and stores the behavior prediction result at the future time t101 of the host vehicle V and the leading vehicle LV and the road shape acquisition unit 10 acquires the road shape information (gradient information) on the traveling road surface of the host vehicle V and the leading vehicle LV at the future time t101, so that the departure determination unit 11 can determine whether the leading vehicle LV departs from the detection ranges SR1, SR2, SR3 of the external environment sensor 1 at the future time t101.

Further, in the signal processing device 7 of the vehicle control device AD1, when the leading vehicle LV actually departs from the detection ranges SR1, SR2, SR3 of the external environment sensor 1 at the current time t101 (corresponding to the future time t101), the integration unit 12 acquires the behavior prediction result corresponding to the current time t101 (instead of the external environment information acquired by the external environment sensor 1), and can regenerate the integration result FU102 in which the leading vehicle information LV100 is merged into the integration result FU101 (in other words, the integration result FU101 interpolated with the leading vehicle information LV100).

Further, in the signal processing device 7 of the vehicle control device AD1, when the leading vehicle information acquired by the external environment sensor 1 is temporarily lost at the current time t101, the integration unit 12 outputs the planned travel route information and the integration result FU102 to the autonomous driving control unit 17, so that the autonomous driving control unit 17 performs vehicle control using the leading vehicle information LV100 in the integration result FU102, thus suppressing a phenomenon in which the host vehicle V accelerates due to losing track of the leading vehicle LV as a target to be followed. As a result, the host vehicle V and the leading vehicle LV can safely travel keeping an adequate vehicle-to-vehicle distance therebetween.

According to the present embodiment 2, as with the aforementioned embodiment 1, a cause for losing track of the leading vehicle LV by the external environment sensor 1 can be more accurately determined as compared to the conventional signal processing devices, so that it is possible to provide the signal processing device 7 capable of more surely keeping a vehicle-to-vehicle distance between the leading vehicle LV and the host vehicle V in traveling by following.

Note that the present invention is not limited to the aforementioned embodiments and includes various modifications. For example, the aforementioned embodiments have been described in detail for easier understanding of the present invention and are not necessarily limited to those including all the described configurations. Further, it is possible to replace a portion of the configuration of one embodiment with that of another embodiment, or it is also possible to add the configuration of one embodiment to the configuration of another embodiment. Further, for a part of the configuration of each embodiment, addition and deletion of or replacement with another configuration may be applicable individually or in combination.

First, in the aforementioned embodiments, acquiring the gradient information on the traveling road surface from the surrounding map information has been described, but the gradient value of the leading vehicle LV may be computed using the road shape that can be acquired from the external environment information from the external environment sensor 1 or the moving amount in the height direction of the leading vehicle LV, instead of using the surrounding map information, or the gradient value of the host vehicle V may be computed from an inclination of the host vehicle V that can be acquired from the vehicle sensor 6.

Further, in the aforementioned embodiments, acquiring the gradient information (gradient value) on the traveling road surface as the road shape information to determine the departure has been described, but altitude information or the like may be acquired in place of or together with the gradient information.

Next, in the aforementioned embodiments, calculating the origin a2 of coordinates and the origin b2 of coordinates from the host vehicle travel information, the object information, and the surrounding map information in the integration result FU1 has been described, but in this respect, the calculation may be performed further accurately by using the behavior of the host vehicle V and the leading vehicle LV immediately before, a database of empirical knowledge in the past, and the surrounding traffic environment information.

Next, in the aforementioned embodiments, outputting the planned travel route information and the integration result FU3 regenerated in step S204 to the autonomous driving control unit 17, in step S205 performed by the integration unit 12, has been described, but for the purpose of clarifying the origin of the integration result FU3, information indicating that the integration result FU3 is a result regenerated based on the behavior prediction result CA1 may also be additionally output to the autonomous driving control unit 17.

Further, the components described above may be in part or entirely configured with hardware or may be implemented by a processor executing programs. Furthermore, the illustrated control and information lines are those considered necessary for the description, but do not necessarily indicate all of those in a product. Almost all the components may be considered actually connected with one another.

### REFERENCE SIGNS LIST

1 External environment sensor
6 Vehicle sensor
7 Signal processing device
9 Behavior prediction unit
Road shape acquisition unit
11 Departure determination unit
12 Integration unit
17 Autonomous driving control unit
20 Vehicle drive unit
AD1 Vehicle control device
CA1 Behavior prediction result
FU1 Integration result
FU2 Integration result
FU3 Integration result
LV Leading vehicle
V Host vehicle

1. A signal processing device comprising:
an integration unit that performs integration processing of external environment information acquired by an external environment sensor mounted on a host vehicle and host vehicle travel information acquired by a vehicle sensor; and
a behavior prediction unit that predicts behavior at a future time of the host vehicle and another vehicle detected by the external environment sensor, based on an integration result from the integration unit,
wherein
the behavior prediction unit includes:
a road shape acquisition unit that obtains road shape information on a traveling road surface of the host vehicle and the other vehicle at the future time; and
a departure determination unit that determines whether the other vehicle departs from a detection range of the external environment sensor at the future time, based on a behavior prediction result of the host vehicle and the other vehicle and the road shape information, and
the integration unit uses the behavior prediction result for the integration processing in accordance with a determination result from the departure determination unit.

2. The signal processing device according to claim 1, wherein the road shape information is gradient information.

3. The signal processing device according to claim 1, wherein when it is determined that the other vehicle departs from the detection range of the external environment sensor at the future time, based on the behavior prediction result of the host vehicle and the other vehicle, and the road shape information, the behavior prediction unit stores the behavior prediction result.

4. The signal processing device according to claim 1, wherein the departure determination unit compares gradient values on the traveling road surface of the host vehicle and the other vehicle at the future time and determines whether the other vehicle departs from the detection range of the external environment sensor at the future time.

5. The signal processing device according to claim 1, wherein when the other vehicle actually departs from the detection range of the external environment sensor at a current time, the integration unit acquires the behavior prediction result corresponding to the current time and regenerates the integration result from the integration unit.

6. The signal processing device according to claim 1, wherein the road shape acquisition unit obtains the road shape information based on map information on the traveling road surface of the host vehicle and the other vehicle at the future time.

7. The signal processing device according to claim 1, wherein the road shape acquisition unit obtains the road shape information based on a road shape that can be acquired from the external environment information from the external environment sensor.

8. The signal processing device according to claim 1, wherein the road shape acquisition unit obtains the road shape information based on a moving amount in a height direction of the other vehicle.

9. The signal processing device according to claim 1, wherein the road shape acquisition unit obtains the road shape information based on an inclination of the host vehicle that can be acquired from the vehicle sensor.
